(19) United States
(12) Patent Application Publication
(10) Pub. No.: US 2022/0132200 A1
(43) Pub. Date: Apr. 28, 2022

(54) METHOD AND SYSTEM FOR DISPLAYING OVERLAY GRAPHICS ON TELEVISION PROGRAMS IN RESPONSE TO VIEWER INPUT AND TRACKING AND ANALYZING VIEWER INPUTS

(71) Applicant: Andrew Flessas, Columbia, TN (US)

(72) Inventor: Andrew Flessas, Columbia, TN (US)

(21) Appl. No.: 17/499,645

(22) Filed: Oct. 12, 2021

Related U.S. Application Data
(60) Provisional application No. 63/091,049, filed on Oct. 13, 2020.

(51) Int. Cl. H04N 21/431; H04N 21/81; H04N 21/442

(52) U.S. Cl. CPC H04N 21/4312; H04N 21/44213; H04N 21/8146

(57) ABSTRACT

A methods and system for receiving viewer input to a television program may include the step of receiving the television program and receiving, during presentation of the television program on a television, at a media box interposed between a media feed and the television, an input from a viewer device. The input may be processed to determine a desired graphic and a designated location for the desired graphic. Based upon the determination, the media box may modify the media feed to create a modified video feed comprising the desired graphic. The modified video feed may be output to the television, whereby the television presents the program with the graphic displayed on program at the designated location. Finally, the media box may report the input to analytic service.

### RELATED APPLICATION DATA

The present application claims priority to U.S. Provisional Application Ser. No. 63/091,049, filed Oct. 13, 2020, which application is incorporated herein by reference in its entirety.

### FIELD OF THE INVENTION

The present invention relates to methods and systems for receiving feedback from viewers of television programs.

### BACKGROUND OF THE INVENTION

Viewing of television programming largely remains a passive activity: a viewer selects a particular program and then sits and watches the program. Networks and program creators may obtain feedback regarding the number of viewers of their programs, such as by either sending surveys to viewers regarding their viewing habits, or by tracking the number of viewers of each program. However, this viewership tracking provides very limited information to the networks and program creators. For example, it may inform a network that a high percentage of viewers tuned into a particular program, but it doesn't inform the network of why that was the case (did viewers like that program much more than other programs, or just the programs that were aired at the same time?; was the time of day or the day of the week an important factor in affecting viewership?, etc.)

Likewise, the passive nature of watching television does not fully engage viewers. These viewers may thus be lost to other media, such as online activities where they can interact with others. In other situations, viewers may supplement their viewing with other activities, such as by posting information to a blog, or engaging others in a chat room. This can be distracting, however, as it requires the viewer to use a mobile phone, laptop or the like to participate in the external media at the same time they are trying to watch the television program.

### SUMMARY OF THE INVENTION

Disclosed is a system for displaying and analyzing viewer designed graphics in association with a television program. The system may include an analyzer server and a media box. The media box may comprise a controller, a communication interface, a memory, and machine-readable code stored in the memory and executable by the controller. The machine-readable code may cause the media box to receive a media feed comprising the television program and receive an input from a viewer device. The media box may process the input to determine a graphic output and a designated location for the graphic output, and to, based upon the determination, associate the graphic output with the media feed so that the modified media feed causes the television to display the television program as including the graphic output at the designated location. The media box may also report to the analyzer server information regarding the viewer input, the information comprising at least information about the graphic output and the designated location and a time of the input in relation to the program.

In one embodiment, the analyzer server may be configured to receive the television program and to generate a telemetry file. The telemetry file may include the media feed and data. The data may include identification of objects or persons in the television program and a location of the objects or persons at different times during the television program. The analyzer server may also be configured to transmit the telemetry file to the media box, wherein the media box is configured to utilize the telemetry file to generate the designated location

The analyzer server may also analyze the input regarding the viewer input to determine one or more of the following: an indication of like or dislike of one or more actors, characters, dialogue or scenes during the program.

Also disclosed is a method of receiving viewer input to a television program, which may include the step of receiving the television program and receiving, during presentation of the television program on a television, at a media box interposed between a media feed and the television, an input from a viewer device. The input may be processed to determine a desired graphic and a designated location for the desired graphic. Based upon the determination, the media box may modify the media feed to create a modified video feed comprising the desired graphic. The modified video feed may be output to the television, whereby the television presents the program with the graphic displayed on program at the designated location. Finally, the media box may report the input to analytic service.

In one embodiment, the viewer device may include a mobile communication device. In one embodiment, that the input may include the selection of one or more graphical icons displayed on the viewer device, and the desired graphic is based on an output file associated with the graphical icon displayed on the viewer device. The desired graphic may include one or more of the following: an image, a video, an animated image, an audio. It also contemplated that the input may include pointing the viewer device at the television and, in response to the output of a cursor appearing on the video feed in response, the cursor may mirror the motion of the viewer device being pointed at the television, such that the cursor at a location on the video feed may be selected. In one embodiment, the designated location may be based on the selection of the cursor at the location on the video feed.

The following additional steps are also contemplated: analyzing the television program and generating a telemetry file comprising the media feed and data. The data may include identification of objects or persons in the television program and a location of the objects or persons at different times during the television program. The telemetry file may be used to generate the designated location.

Also disclosed is a system for displaying and analyzing viewer designed graphics in association with a television program. The system may include a media box. The media box may include a controller, a communication interface, a memory, and machine-readable code stored in the memory and executable by the controller. The machine-readable code may cause the media box to receive a media feed comprising the television program and receive an input from a viewer device. The media box may process the input to determine a graphic output and a designated location for the graphic output. Based upon the determination, the media box may superimpose the graphic output over the media feed at the designated location such that the graphic output is displayed on the television program on the television.

In one embodiment, the viewer device may include one or more of the following: a mobile communication device, a remote controller device, and a remote console device. In one embodiment, the input may include the selection of one or more icons displayed on the viewer device, and the graphic output may be based on an output file associated with the icon. Further, the graphic output may be randomly generated based on one or more output files associated with the icon. It is also contemplated that the graphic output may include one or more of the following: an image, a video, an animated image, an audio. In one embodiment, the input may include pointing the viewer device at a first location on the display of the media feed; and the media box may be further configured to, in response to the pointing, display a cursor appearing on the media feed at the first location. Further, the designated location may be based on the first location. It is also contemplated that the input may include changing the first location to a second location on the display of the media feed; and the media box may be further configured to, in response to the change, display the cursor appearing on the media feed at the second location.

### DESCRIPTION OF THE DRAWINGS

FIG. 1 illustrates a system in accordance with an embodiment of the invention;

FIG. 2 illustrates exemplary hardware in one embodiment of a media box of the invention; and

FIG. 3 is a flow diagram of a method of an embodiment of the invention.

### DETAILED DESCRIPTION OF THE INVENTION

In the following description, numerous specific details are set forth in order to provide a more thorough description of the present invention. It will be apparent, however, to one skilled in the art, that the present invention may be practiced without these specific details. In other instances, well-known features have not been described in detail so as not to obscure the invention.

One embodiment of the invention is a method and system for displaying overlay graphics on television programs in response to viewer input, and for tracking and analyzing such viewer inputs. As one example, a viewer of a television program may provide an input to an input device to cause a graphic overlay to be displayed on the television program. Different graphics may be displayed or selected, where the graphics may have different characteristics, such as where the characteristics are indicative of emotion, sentiment, reaction or the like. For example, a viewer's negative reaction to displayed television content might be reflected in an input from the viewer which causes a “tomato splat” to be displayed on the face of a person who appears in the program. The viewer's input, including the different types or inputs or selected graphics may be tracked, as well as the location and/or time of the input. This information may be used to identify viewer pleasure or displeasure, for example, regarding particular individuals (actors, actresses or the characters played thereby), statements, scenes and the like, of a particular program.

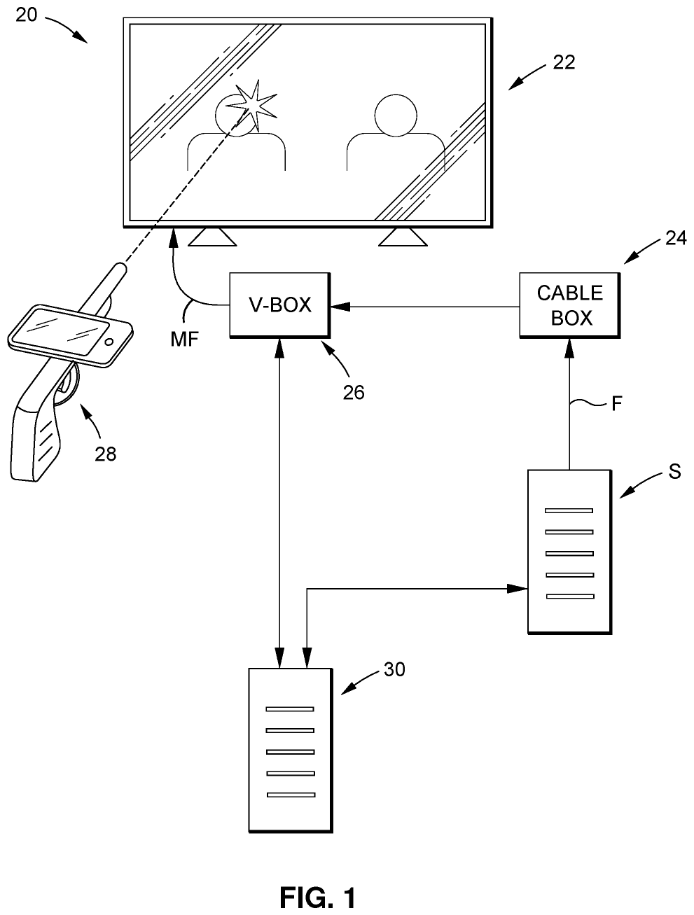

One embodiment of a system 20 of the invention will be described with reference to FIG. 1. As illustrated, a television or other display (such as a projector, computer monitor, etc.) 22 may be configured to display information. The television 22 may be any of a variety of types now known or later developed (CRT, LED, Plasma, LCD, DLP, OLED, etc.). In one embodiment, a media feed F is provided to the television 22. The media feed F may comprise, for example, an audio/video feed of one or more programs. The media feed F may comprise, for example, a feed of one or more television programs, movies, sports events, reality shows, etc.

The media feed F may be provided from a programming source S. The source S might comprise, for example, a cable provider, satellite network provider, over the air broadcaster, or the like. In one embodiment, the media feed F is transmitted from the source S over one or more communication links or networks, such as a cable network, a satellite network, the Internet, wirelessly over the air, etc.

In one embodiment, the media feed F may be directly provided to the television 22. For example, the media feed F might be received by an antenna of the television 22. In other embodiments, the media feed F might be received by a cable box 24 or other receiver/tuner/signal processor (set top box, satellite receiver, etc.) and then processed and output to the television 22. For example, relative to a cable media feed, the cable box 24 may be used to convert a digital media feed signal to analog, to unscramble or decode a feed signal, etc. The output from the cable box 24 may be provided to the television 22 for display.

In accordance with the invention, a media box or “VBox” 26 is provided. The VBox 26 is preferably positioned along the media feed path before the television 22. For example, when there is no cable box/tuner 24, the VBox 26 might be positioned between an output of an antenna and an input to the television 22. When a cable box 24 is being used, the VBox 26 may be positioned between the output of the cable box 24 and the input to the television 22. The VBox 26 is preferably configured to implement the functionality below, including associating graphics with the media feed F, thus creating a modified media feed MF which is provided to the television 22.

In one embodiment, the VBox 26 comprises a controller, a memory, machine-readable code (e.g. “software”) stored in the memory and executable by the controller, and one or more communication interfaces. The communication interfaces may include a variety of ports, such as for wired (including co-ax, Ethernet, DVI, HDMI or other) and/or wireless communication links (including Bluetooth, Wi-Fi, infrared, RF or other). The communication interfaces may be configured to output information or data generated by the controller, and receive data or information which is provided to the controller. For example, the media output of a cable box 24 may be provided to an input of the VBox 26 via an HDMI cable and associated HDMI ports on both boxes. The media output of the VBox 26 may be provided to an input of the television 22 via an HDMI cable and associated HDMI ports on both boxes.

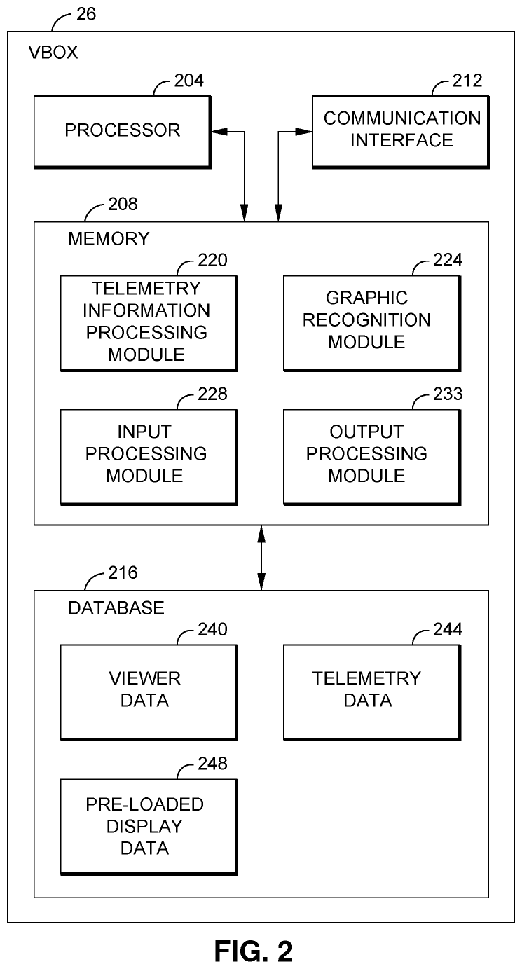

In one embodiment, the VBox 26 might comprise or be based upon a Raspberry Pi device. The software may comprise or include graphics rendering software, such as the Unreal Engine 4 by Unreal Engine. The VBox 26 may comprise other casting or streaming devices such as Chromecast, Amazon Fire TV Stick, Apple TV, etc. Additional details of one embodiment of a VBox 26 are provided in more detail below with reference to FIG. 2.

The system 20 also includes or is configured to interface with one or more viewer input devices 28. The viewer input device 28 might comprise remote control, a console controller, a mobile communication device such as a phone, smartphone, tablet, other hand-held controllers where a user may provide input such as arm motion, hand gestures, and various selection or control input through buttons or joysticks on such controller, or any other user or electronic devices configured to receive input from a viewer and generate/transmit an output. This output may be transmitted in various fashions, including wirelessly (including by, for example, Bluetooth or Wi-Fi). The output may be received by the VBox 26.

The input device 28 might also comprise a specialized device, such as a specialized input device which is configured to receive particular inputs and generate particular outputs, and/or where the configuration of the device is uniquely configured. For example, for reasons noted below, the viewer input device 28 might comprise a simulated firearm, such as having a barrel, a grip or stock, a trigger, etc. The trigger might be used as an input device, such as by having a detector associated therewith. The detector might provide a signal (when the trigger is actuated) to a controller, which controller is configured to generate an output signal, such as wirelessly. This output signal may be received by the VBox 26.

In one embodiment, the viewer input device 28 is configured to not only provide a signal to the VBox 26 indicative of a viewer actuation input (such as a “trigger pull”), but preferably also includes location information. For example, in the case of a viewer input device 28 which comprises an iPhone® by Apple, the device may run an application called Remote Mouse. This application allows a user to provide touch input to a display screen of the device in order to provide a location input—e.g. to designate a desired location for the graphic to be displayed. This location input can be received by the VBox 24 to associate a graphical pointer with the media feed F as part of the modified feed MF. The television 22 then displays the video portion of the media feed MF with the pointer. As the viewer moves their finger on the screen of their user device 28, that location information is provided to the VBox 26, which in turn causes the position of the graphically displayed pointer to move. In one embodiment, this allows a viewer to designate a particular location of the displayed video on the television 22.

The viewer may then provide a triggering input, such as by providing a secondary input to their input device (such as their phone or, in the case of the example specialized input device comprising a simulated firearm, a trigger pull). This secondary input is provided to the VBox 26. This causes the VBox 26 to cause the display of graphical content, such as a graphical event, relative to the displayed media feed. This graphical content might comprise, for example, a “tomato splat” at the designated location of the television screen, or the display of other graphics or graphical information.

As indicated in FIG. 1, in one embodiment, the viewer input device 28 might comprise a combination of a communication device such as a phone or tablet, and a secondary object, such as a simulated firearm. In this configuration, the viewer may provide location information by touch input to the display of the phone, and then pull the trigger of the firearm in order to provide the actuation input. The actuation output may be provided by the secondary object, or might be generated by the phone or tablet (such as by connecting the secondary object, such as trigger controller) to thereto.

As indicated herein, the displayed graphics or graphical information may have associated characteristics, such as where the characteristics are indicative of emotion, sentiment, reaction or the like. The viewer might be permitted to select the particular graphics they wish to be displayed, such as via input to the VBox 26 (such as via their viewer input device 28). For example, the viewer might cause the VBox 26 to display a “tomato splat” on the face of a displayed actor/character in order to express displeasure with the actor/character, including their appearance, personality, actions or dialogue. In other examples, a viewer might cause the VBox 26 to display a heart on an actor/character in order to express pleasure. Of course, a wide range of graphics might be selected and/or displayed. The graphics may be static or moving, may comprise emojis, objects or other elements. For example, if a character who was eating a salad in a displayed movie was found to be undesirable by a viewer, the viewer might cause a cockroach to be displayed in the salad. A viewer might express that they like a particular character, for example, by associating a heart with the character.

In one embodiment, the graphics might be categorized or have an assigned meaning, whereby when selected and used by a viewer, the meaning of the selected graphic can be directly determined. For example, a “tomato splat” might be assigned a meaning of “intense dislike” and a “X” symbol might be assigned a meaning of “moderate dislike”, whereby when one or more viewers utilize those graphics, a measure of the dislike of the viewers can be determined by which of those graphics are selected and used.

In accordance with the invention, the VBox 26 modifies the media feed F by associating the designated graphics with the media feed F, thus creating a modified media feed MF that is displayed by the television 22. Further, the VBox 26 preferably associates the designated graphics with a particular location of the displayed video (as designated by the viewer). For example, the location might be the face of an actor or character.

The VBox 26 may associate the graphics with the video content in a variety of manners. In one embodiment, the VBox 26 obtains “telemetry” information regarding a program that is being displayed. As illustrated in FIG. 1, the system 20 may include an analyzer 30. The analyzer 30 may itself comprise a system or a computer, such as a server. The analyzer 30 may, for example, comprise a processor, a memory, machine-readable code stored in the memory and executable by the processor, and one or more communication interfaces. The analyzer 30 might, for example, receive a program, such as from the programming source S. The analyzer 30 may then analyze the program, such as to generate a data file which represents data regarding the position of persons or portions thereof (such as a face, body, etc.) or objects, of the program at designated times. This telemetry file may be uploaded to the VBox 26. Then when the program is selected for viewing by the viewer or is otherwise aired, the VBox 26 has an associated telemetry file for that program.

The VBox 26 may then receive an actuation input from a viewer to associate a graphic with a program at a designated position. The VBox 26 may correlate that input to the proper location of the displayed content using the telemetry file. As one example, at a particular time in a displayed program, an actor may be shown. The viewer may provide an actuation input of a “tomato splat.” When the VBox 26 receives this input, the viewer designated location may correlate to the shoulder of the displayed actor. The VBox 26 may use the telemetry information to cause the graphic to thus be displayed over the face of the actor (e.g., modifies the viewer designated location to be accurate). As another example, the VBox 26 may use the telemetry information to ensure that the displayed graphics remain aligned with the desired target. For example, a viewer may designate a “tomato splat” at an actor's face at a designated time. Of course, in the program, the position of the actor's face may change, either between the time the viewer makes the input and the graphic is displayed, or after/as the graphic is displayed. The VBox 26 may use the telemetry data, which designates the location of the actor's face at different times in the program, to move the displayed graphic (of the tomato splat) so that it remains on the face of the actor as the actor moves (such as over a period of a few seconds or more).

Of course, the VBox 26 might be configured to perform similar functionality in other manners, such as by having a video recognition capability which allows the VBox 26 to analyze the program and identify persons, objects, etc., and their locations at different times. In this manner, the VBox 26 may cause the position of a designated graphic to change or move over time.

In one embodiment of the invention, the VBox 26 preferably provides an output to the analyzer 30. This output might be transmitted for example, via a connection of the VBox 26 to the Internet or other communication link to the analyzer 30. The output might comprise, for example, information regarding viewer inputs, such as the selected graphic, and the time and location of each input. This information may be correlated to information regarding the program, or might be matched by the analyzer 30 to the program.

The information may be used by the analyzer 30 (or a third party system) to generate a wide variety of information. For example, the output from the VBox 26 may be used to analyze the habits or activities of a particular viewer. For example, a particular viewer might provide a “tomato splat” (or other ‘negative’ input) to a particular actor or character or a program. This information might be used to determine that the viewer does not like that actor or program character (or, relative to a particular program, to generate a hierarchy of the actors/characters from most liked to most disliked). The same information might be analyzed to determine that a viewer likes or does not like particular dialogue or statements, images/scenes or the like.

In accordance with a system 20 of the invention, multiple viewers may have their own VBox 26 and viewer input device 28 which are in communication with the analyzer 30. Thus, the information from multiple viewers may be aggregated, such as to provide information about which actors or characters, content, scenes, etc. of a program are most liked or disliked, etc. This information may be used by the program creators in a variety of manners, including in the generation of new programs, eliminating characters, etc.

An important aspect to this component of the invention is that the analyzer 30 receives information regarding inputs of a viewer which relate to particular persons, objects or events in a program at particular times. In other words, the information is not merely a “rating” that the viewer provides at the end of the program that ranks the entire program (such as 1 to 4 stars), but comprises discrete inputs having associated characteristics, where those inputs are tied to particular persons, objects, content, etc. at specific times, including the potential for multiple inputs by the viewer in a single program, where those inputs may vary in nature and be at different times and relate to different people, objects or content, etc.

In a preferred embodiment, the VBox 26 not only associates graphics or graphical information with the media feed F to create a modified media feed MF, the VBox 26 may associate audio information. For example, if the viewer provides an input for a “tomato splat”, the VBox 26 may associate the tomato splat graphics, and also an audio of a tomato splat, whereby a sound system associated with the television 22 (integrated or separate) thus present audio from the media feed F and also associated with the graphic event. Of course, the additional audio may be a variety of sounds, words, etc.

Exemplary hardware in one embodiment of the VBox 26 is illustrated in FIG. 2. The VBox 26 may comprise a processor 204, a memory 208, machine-readable code stored in the memory 208 and executable by the processor 204, one or more communication interfaces 212, and a database 216 storing data used by the machine-readable code. The machine-readable code may comprise a telemetry information processing module 220, a graphic recognition module 224, one or more input processing module 228, and an output processing module 236. The database 216 may comprise viewer data 240, telemetry data 244, and pre-loaded display data 248.

As discussed above, the VBox 26 may obtain telemetry files from programs being displayed. Such telemetry files may be stored as telemetry data 244, and may be processed by the telemetry information processing module 220 in conjunction with other processing modules to output the desired display of a user/viewer. Using an example above, a viewer may provide an input of a “tomato splat” but aimed it at an actor's shoulder. The system may, based on analysis of viewer data 240 (discussed below) or pre-loaded display data 248 (discussed below), determine that the “tomato splat” should appear on an actor's head instead. The telemetry information processing module 220 may thus identify the actor's head as the correct location for the output of the “tomato splat”.

Alternatively, where a program is on display but no associated telemetry files may be identified, or where the telemetry file is corrupted or incomplete, the graphics recognition module 224 may be used to supplement the functions of the telemetry information processing module 220. Using the same example, where a viewer provided an input of a “tomato splat”, the graphics recognition module 224 may process the program output to identify the location of an actor's head on display, such that the correct location may be associated with the output of the “tomato splat”.

The input processing module 228 may be used to process viewer input. Such input may include active input such as the triggering input and location information discussed above, to determine the viewer's desired graphical display (such as a “tomato splat”), and where such graphical display is desired (such as on an actor's head). Where a user device may display various options for graphical display, the viewer input may be a selection of a desired graphical display. Where a user device may display a graphical icon (such as graphical icons), the user input may be a selection of a graphical icon, which may then be associated with a graphical display. For example, the viewer may input a viewer setting (discussed more below) to associate a circle icon with a “tomato splat”. Upon pressing a key associated with the graphical icon, the input processing module 228 may determine the proper response output is the graphical display of a “tomato splat”. Alternatively, a viewer device may include several emojis. Upon receiving a viewer input of an angry face emoji, the input processing module 228 may determine the viewer's wish to output a graphical display indicating negative feelings. Such graphical display may be pre-selected by viewer setting, or may be randomly generated from a collection of one or more graphical displays associated with negative feelings. The output processing module 232 may be used to generate the proper output in response to the viewer's input (such as the display of a “tomato splat” on an actor's head).

Viewer data 240 may comprise any information about VBox 26 users. Such data may comprise viewer settings (such as volume and brightness control), viewer preferences (such as preferred graphic content and their respective size, colors, animation, or associated audio, which may be selected by active input or generated passively based on viewer history), and viewer history (such as data on a viewer's past input). In one embodiment, each user may have his/her own viewer account such that viewer data may be separated by user accounts

Telemetry data 244 may include telemetry files imported from connected devices such as cable box 24, programming source S, or user devices used to cast/stream a program on the television 22. Telemetry data 244 may also include data generated by the graphic recognition module 224. For example, where no prior telemetry file exists, the graphic recognition module 224 may be used to analyze and create a telemetry file of the program currently on display on the television 22, and such telemetry file may be stored for future uses.

Pre-loaded display data 248 may include graphic and audio content files a viewer may select for output (such as images, animation videos, and audio files for a “tomato splat”). Display data 248 may comprise display restrictions (such as a “tomato splat” may only be displayed on a person's head, whereas a rainbow may appear on a person's shoulder). Such display restrictions may be customized in viewer setting. In one embodiment, a viewer may upload or retrieve additional pre-loaded display data 248 from other sources (such as image, gif, or audio files from a viewer's computer, which a viewer may download from the Internet or manually create).

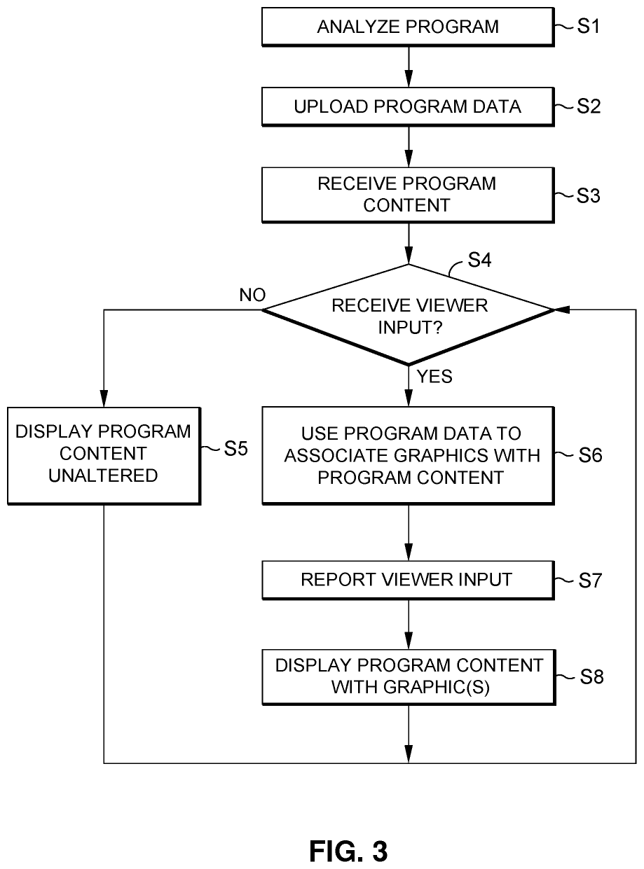

One embodiment of a method of the invention is illustrated in FIG. 3. As illustrated, in a step S1, a program may be analyzed (such as by the analyzer 30 of the system 20 illustrated in FIG. 1, the telemetry information processing module 220, and/or the graphic recognition module 224). The analysis may generate image or “telemetry” information for the program, as described above. This analysis is preferably performed before the program is aired or presented to the viewer, such as via a telemetry file provided by the source of the program.

In a step S2, the program data is uploaded, such as from the analyzer 30 to the VBox 26. This step may be skipped if the analysis discussed in step S1 is performed in the VBox 26 (such as via the telemetry information processing module 220, and/or the graphic recognition module 224). The data may be uploaded as one or more data files. The upload might occur at designated times (for example, during the night based upon programs which are set to air the next day), at the time a user select a program to watch, or otherwise.

In a step S3, the VBox 26 receives program content. This may comprise a media feed F for a program that has been selected by a viewer (such as by tuning to a channel of the cable box 24).

In a step S4, it is determined whether the viewer has provided an actuation input. If not, then the VBox 26 may pass the media feed F to the television 22 for display, as at step S5. In other words, if the viewer has not provided an actuation input, the program is presented unaltered.

In step S4, if the viewer has provided an actuation input, then in a step S6, the VBox 26 preferably associates the designated graphics (and/or audio) with the media feed MF, to create a modified media feed MF. This may be performed using the one or more input processing modules 228 illustrated in FIG. 2 and discussed above.

In a step S7, the viewer input is preferably reported, such as from the VBox 26 to the analyzer 30. This may comprise reporting what type of input that the viewer made, including the type of graphic selected, the designated location, and the time in the program. As indicated above, the analyzer 30 may then use this information in various analytics.

Such analytics may include generating user data, which may be used to enhance search algorithms, newsfeed, and advertisements to the viewer, which may be used in combination with third-party services such as user devices and user accounts. For example, where a viewer input indicates a user preference for teen drama, and a particular teen actor, the viewer's accounts may be updated with such preference to generate more advertisements for upcoming teen drama movies and products promoted by the teen actor. Such analytics may also include generating program data, which may be used to enhance future content. For example, where a collection of viewer input indicates the majority of viewers prefer action movies, such program data may be used by the film industry to determine what type of future movies to invest in. Similarly, where a collection of viewer input indicates the majority of viewers prefer a first actor in action movies, but not in horror movies, and prefer a second actor in horror movies, but not in action movies, such program data may be used by movie producers in future casting choices.

In a step S8, once the media feed F has been modified by the VBox 26, the VBox 26 outputs the modified video feed MF, causing the television 22 to present the program in a modified fashion—e.g. by displaying the program with secondary graphics and/or audio. This may be performed using the output processing module 233 illustrated in FIG. 2 and discussed above.

As illustrated, the process of steps S4-S8 may be repeated during a single program (and may be used in other programs).

In one embodiment, the video display which displays the media feed, including as modified as described herein, may comprise a robotic video display, such as illustrated and described in U.S. Pat. No. 7,545,108, or a robotic projector and/or robotic screen, as illustrated and disclosed in U.S. Pat. No. 9,794,533, the contents of which are incorporated by reference entirely herein. In such a configuration, the viewer may also control such robotic displays or screens, such as to move, or such movement may be implemented by the VBox 26. For example, if a viewer provides an input to display a “tomato splat”, the VBox 26 might cause the robotic display to move towards the viewer as the “tomato splat” is displayed, heightening the effect of the graphic.

It will be understood that the above described arrangements of apparatus and the method there from are merely illustrative of applications of the principles of this invention and many other embodiments and modifications may be made without departing from the spirit and scope of the invention as defined in the claims.

What is claimed is:

1. A system for displaying and analyzing viewer designed graphics in association with a television program comprising:
an analyzer server; and
a media box comprising a controller, a communication interface, a memory, and machine-readable code stored in said memory and executable by said controller to cause said media box to:
receive a media feed comprising said television program;
receive an input from a viewer device;
process said input to determine a graphic output and a designated location for said graphic output;
based upon said determination, to associate said graphic output with said media feed so that said modified media feed causes said television to display said television program as including said graphic output at said designated location, and
to report to said analyzer server information regarding said viewer input, said information comprising at least information about said graphic output and said designated location and a time of said input in relation to said program.

2. The system in accordance with claim 1, wherein said analyzer server is configured to receive said television program, generate a telemetry file comprising said media feed and data, said data comprising identification of objects or persons in said television program and a location of said objects or persons at different times during said television program, and to transmit said telemetry file to said media box, wherein said media box is configured to utilize said telemetry file to generate said designated location.

3. The system in accordance with claim 1, wherein said analyzer server analyzes said input regarding said viewer input to determine one or more of: an indication of like or dislike of one or more actors, characters, dialogue or scenes during said program.

4. A method of receiving viewer input to a television program comprising:
receiving said television program;
receiving, during presentation of said television program on a television, at a media box interposed between a media feed and said television, an input from a viewer device;
process said input to determine a desired graphic and a designated location for said desired graphic;
based upon said determination, said media box modifying said media feed to create a modified video feed comprising said desired graphic;
outputting said modified video feed to said television, whereby said television presents said program with said graphic displayed on program at said designated location; and
reporting, from said media box, said input to analytic service.

5. The method in accordance with claim 4, wherein said viewer device comprises a mobile communication device.

6. The method in accordance with claim 4, wherein said input comprises the selection of one or more graphical icons displayed on said viewer device, and said desired graphic is based on an output file associated with said graphical icon displayed on said viewer device.

7. The method in accordance with claim 4, wherein said desired graphic comprises one or more of the following: an image, a video, an animated image, an audio.

8. The method in accordance with claim 4, wherein said input comprises pointing said viewer device at said television and, in response to the output of a cursor appearing on said video feed in response, said cursor mirroring the motion of the viewer device being pointed at said television, the selection of said cursor at a location on said video feed.

9. The method in accordance with claim 8 wherein said designated location is based on said selection of said cursor at said location on said video feed.

10. The method in accordance with claim 4 comprising the additional step of analyzing said television program, generating a telemetry file comprising said media feed and data, said data comprising identification of objects or persons in said television program and a location of said objects or persons at different times during said television program, and using said telemetry file to generate said designated location.

11. A system for displaying and analyzing viewer designed graphics in association with a television program comprising:
a media box comprising a controller, a communication interface, a memory, and machine-readable code stored in said memory and executable by said controller to cause said media box to:
receive a media feed comprising said television program;
receive an input from a viewer device;
process said input to determine a graphic output and a designated location for said graphic output; and
based upon said determination, superimpose said graphic output over said media feed at said designated location such that said graphic output is displayed on said television program on said television.

12. The system in accordance with claim 11, wherein said viewer device comprises one or more of the following: a mobile communication device, a remote controller device, and a remote console device.

13. The system in accordance with claim 11, wherein said input comprises the selection of one or more icons displayed on said viewer device, and said graphic output is based on an output file associated with said icon.

14. The system in accordance with claim 13 wherein said graphic output is randomly generated based on one or more output files associated with said icon.

15. The system in accordance with claim 11, wherein said graphic output comprises one or more of the following: an image, a video, an animated image, an audio.

16. The system in accordance with claim 11, wherein said input comprises pointing said viewer device at a first location on said display of said media feed; and said media box is further configured to, in response to the pointing, display a cursor appearing on said media feed at said first location.

17. The system in accordance with claim 16, wherein said designated location is based on said first location.

18. The system in accordance with claim 16, wherein said input comprises changing said first location to a second location on said display of said media feed; and said media box is further configured to, in response to said change, display said cursor appearing on said media feed at said second location.
